(19) United States
(12) Patent Application Publication
(10) Pub. No.: US 2022/0284830 A1
(43) Pub. Date: Sep. 8, 2022

(54) AMINO ACID, PEPTIDE CHAIN, AND PROTEIN TEACHING AID SYSTEM

(71) Applicant: Maoyen Chi, New York, NY (US)

(72) Inventor: Maoyen Chi, New York, NY (US)

(21) Appl. No.: 17/745,647

(22) Filed: May 16, 2022

Related U.S. Application Data
(63) Continuation-in-part of application No. PCT/CN2020/132429, filed on Nov. 27, 2020.

(30) Foreign Application Priority Data
Nov. 29, 2019 (CN) 201911199755.8

(51) Int. Cl. G09B 23/26

(52) U.S. Cl. CPC G09B 23/26

(57) ABSTRACT

A comprehensive protein chemistry teaching aid system including 20 different amino acid models, from which peptide chains or protein models can be constructed. The amino acid model includes first, second and third part models, any two of which are detachably connected to each other with an angle. The first part model includes a first connector and a carboxyl group model and alpha-carbon model arranged at two ends of the first connector respectively. The second part model includes an amino group model rotatably connected to the alpha-carbon model. The third part model includes an R group model rotatably connected to the alpha-carbon model. The peptide chain teaching aid is composed of a plurality of the amino acid models connected head to tail. The protein teaching aid is composed of a plurality of polypeptide chains models and folded into a specific three-dimensional structure determined by the contained amino acid sequences.

### TECHNICAL FIELD

The invention relates to the field of genetics, and in particular to a comprehensive teaching aid system composed of amino acids, peptides and proteins.

### BACKGROUND

Protein is polymeric compound formed by combining amino acids linked via peptide bond. There are 20 different kinds of amino acids that make up proteins, and they are glycine (Gly, G), alanine (Ala, A), valine (Val, V), leucine (Leu, L), isoleucine (Ile, I), phenylalanine (Phe, F), proline (Pro, P), tryptophan (Trp, W), serine (Ser, S), tyrosine (Tyr, Y), cysteine (Cys, C), methionine (Met, M), asparagine (Asn, N), glutamine (Gln, Q), threonine (Thr, T), aspartic acid (Asx, B), glutamic acid (Glu, E), lysine (Lys, K), arginine (Arg, R) and histidine (His, H), each has designated abbreviations in parenthesis. Every amino acid consists of three parts, i.e., a positively charged amino group, a negatively charged carboxyl group, and 20 different R groups, which is connected to the alpha-carbon atom in between of the amino and carboxy groups. Within an amino acid, the R group can rotate to obtain a spatial configuration with the lowest energy, in which the amino acid has the most stable structure. Two amino acids can be linked by a peptide bond, and the peptide bond is rigid, means it can not rotate.

Currently, there is no suitable teaching aid in the market that can assemble any polypeptide chain with the whole set of 20 different amino acids and subsequently demonstrate the proper folding of the polypeptide chain, a crucial property of proteins to carry out its various physiological tasks. Taking a molecular structure model of an amino acid disclosed in the patent CN2496090Y as an example, the model is formed by connecting a bag-like balloon representing an R group, a regular hexahedron representing an amino group, a sphere representing a carboxyl group, and an ellipsoid representing a hydrogen atom which are connected to a tetrahedron representing a carbon atom by iron rods representing chemical bonds. Although the model can intuitively present the molecular structures of 20 types of amino acids, the R group is represented by a bag-like balloon in this technical scheme, and hence the structure is not very stable, and various amino acids cannot be distinguished thereby. More importantly, this model can ONLY presenting a fixed structure of one single amino acid molecule, it cannot assemble even a single peptide chain because all of its amino acids are the same, nor can it simulate the principle of protein folding.

### SUMMARY

To offer a far better solution, which can demonstrate all the biochemical principles of amino acids and protein chemistry, the present invention provides a comprehensive teaching aid system composed of 20 different amino acids, which can form head-to-tail amino-carboxy peptide bonds, and subsequently can assemble peptide chain with any amino acid sequence and with length. Finally the protein formed by this artificially assembled polypeptide chain can be folded into proper 3-D structure.

A first technical scheme provided in the present invention is:

An amino acid teaching aid system, including a first part model, a second part model and a part model, any two of these parts are detachably connected with an angle to each other, wherein the first part model includes a first connector, a carboxyl group model arranged at one end and an alpha-carbon model arranged at the other end of the first connector, the second part model includes an amino group model rotatably connected to the alpha-carbon model, and the third part model includes an R group model rotatably connected to the alpha-carbon carboxy model.

In some preferred embodiments, the amino group model of the amino acid teaching aid is detachably connected to a carboxyl group model of an adjacent amino acid model, forming a non-rotatable rigid peptide bond.

In some preferred embodiments, the second part model further includes a second connector and a third connector which are connected at an angle to each other, and the alpha-carbon model is arranged at a joint between the second connector and the third connector.

In some preferred embodiments, the second connector includes a flat-blade structure located at one end of the amino group, and the carboxyl group model of the first connector includes an insert groove for mating with the second connector and arranged on a side opposite the first connector.

In some preferred embodiments, the first part model further includes a fourth connector and a fifth connector, both of which are connected to the alpha-carbon model, and any two of the first connector, the fourth connector, and the fifth connector are arranged at an angle to each other.

In some preferred embodiments, the third part model further includes a sixth connector arranged at one end of the R group model, the sixth connector including a ring plug-in structure; and the fourth connector includes an annular slot structure for mating with the sixth connector.

In some preferred embodiments, the second connector includes an annular slot structure, and the fifth connector includes a ring plug-in structure for mating with the second connector.

In some preferred embodiments, the first connector is integrated with the carboxyl group model; or

the first connector is detachably connected to the amino group model.

In some preferred embodiments, the amino group model is colored in blue and the carboxyl group model is colored in red.

In some preferred embodiments, the R group model includes 20 types, and the structure of the R group model in each amino acid teaching aid is similar to the molecular structure of an R group in a corresponding amino acid.

A second technical scheme provided in the present invention is:

a peptide chain teaching aid composed of a plurality of amino acid teaching aids connected head to tail.

In some preferred embodiments, in the peptide chain teaching aid, an amino group model of each amino acid teaching aid is detachably connected to a carboxyl group model of an adjacent amino acid teaching aid.

A third technical scheme provided in the present invention is:

a protein teaching aid composed of a plurality of amino acid teaching aids connected head to tail.

The beneficial effects provided by the embodiments of the invention are as follows:

1. The invention seeks to protect an amino acid teaching aid including a first part model, a second part model, and a third part model, any two of which are detachably connected at an angle to each other, wherein the first part model includes a first connector, a carboxyl group arranged at one end of the first connector and an alpha-carbon model arranged at the other end of the first connector, the second part model includes an amino group model rotatably connected to the alpha-carbon model, and third part model includes an R group model rotatably connected to the alpha-carbon model. The amino acid teaching aid intuitively presents the structures of various parts of an amino acid via the three detachable part models. Moreover, the carboxyl group model and the alpha-carbon model, as well as the R group model and the alpha-carbon model are arranged to be rotatably connected, respectively, and the alpha-carbon model is arranged to be rigidly connected to the carboxyl group model of an adjacent amino acid, which can vividly present the property that the R group in the amino acid molecule can turn around a peptide bond and rotate to adjust its spatial position to obtain the most stable structure.

2. The amino acid teaching aid of the invention includes an amino group model detachably connected to a carboxyl group model of an adjacent amino acid teaching aid to form a non-rotatable peptide bond, and in particular shows rigid and non-rotatable characteristics of the peptide bond by a mating structure between a strip- or flat-blade structure slot.

3. The peptides or the proteins of this invention are formed between an amino and a carboxyl groups of two adjacent amino acid models in the head-to-tail fashion, precisely and vividly demonstrate the process of peptide chain or protein formation.

### BRIEF DESCRIPTION OF DRAWINGS

In order to illustrate more clearly the technical schemes in the embodiments of the present invention or the related art, the accompanying drawings used in the description of the embodiments will be briefly described below, and obviously, the accompanying drawings in the following description show only some embodiments of the present invention, and for those of ordinary skill in the art, other drawings can be derived on the basis of these drawings without any creative effort.

FIG. 1 is a schematic structural view of an amino acid teaching aid provided in Example 1 of the present invention;

FIG. 2 is a schematic assembly view of an amino acid teaching aid provided in Example 1 of the present invention;

FIG. 3 is a schematic structural view of 20 types of R group models provided in Example 1 of the present invention;

FIG. 4 is a schematic structural view of a peptide chain teaching aid provided in Example 2 of the present invention.

### DETAILED DESCRIPTION

In order to make the objectives, technical schemes and advantages of the present invention clearer, the technical schemes in the embodiments of the present invention are clearly and completely described in the following with reference to the accompanying drawings in the embodiments. It is obvious that the described embodiments are only some of the embodiments instead of all the embodiments of the present invention. All other embodiments obtained by those of ordinary skill in the art based on the embodiments of the present invention without creative effort are within the scope of the present invention.

In the description of the present invention, it should be understood that, descriptions relating to orientation, for example, orientation or positional relationships indicated by terms such as “X-axis”, “Y-axis”, “Z-axis”, “perpendicular”, “parallel”, “up”, “down”, “front”, “back”, “left”, “right”, “vertical”, “horizontal”, “top”, “bottom”, “inside”, and “outside”, are based on the orientation or positional relationships shown in the accompanying drawings, and are to facilitate the description of the present invention and simplify the description only, rather than indicating or implying that the device or element referred to must have a specific orientation or be constructed and operated in a specific orientation, and therefore cannot be construed as limiting the present invention. In addition, the terms “first” and “second” are for the purpose of description only and should not be construed as indicating or implying relative importance or implicitly indicating the number of technical features indicated. Thus, features defined with “first” and “second” may include one or more of the features either explicitly or implicitly.

In the description of the present invention, the term “plurality” means two or more, unless otherwise specified. It should be noted that, in the description of the present invention, the terms “mount”, “engage”, and “connect” should be interpreted in a broad sense unless explicitly defined and limited otherwise, which, for example, can mean a fixed connection, a detachable connection or an integral connection; can mean a mechanical connection or an electrical connection; and can mean a direct connection, an indirect connection by means of an intermediary, or internal communication between two elements. For those of ordinary skill in the art, the specific meaning of the terms mentioned above in the present invention should be construed to specific circumstances.

Considering that most of the current amino acid-related teaching aids can only rigidly present a fixed structure of an amino acid molecule or a structure of peptide chain with a fixed length, and cannot truthfully show the charge distribution or the stable structure of an amino acid molecule nor present the microscopic phenomena of how to connect a plurality of amino acids to form a peptide chain or even a protein, to manifest these microscopic phenomena as much as possible, the examples of the invention presents the microscopic phenomena and structures by constructing an amino acid teaching aid and a peptide chain teaching aid composed of a plurality of amino acid teaching aids.

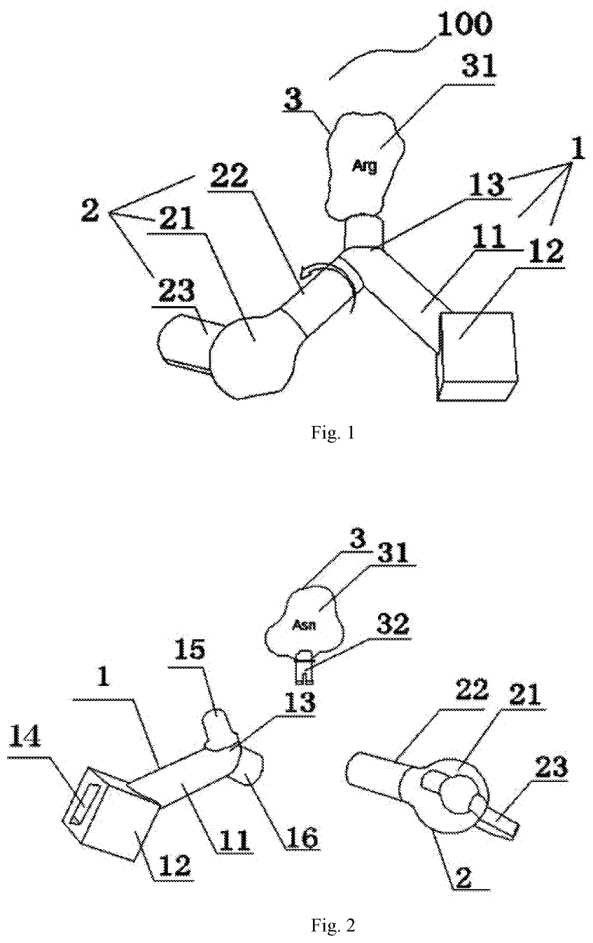

Hereinafter an amino acid teaching aid, a peptide chain teaching aid, and a protein teaching aid in the present application will be described in detail with reference to FIGS. 1-4.

### Example 1

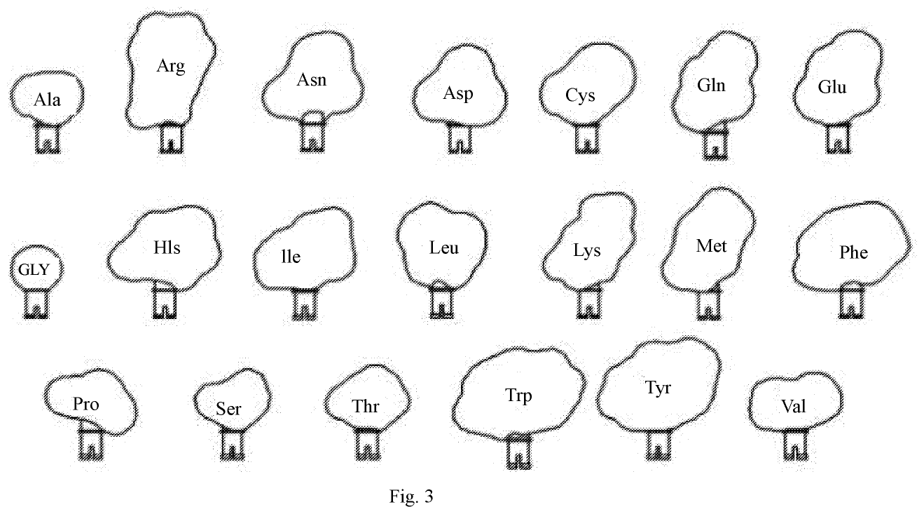

As shown in FIGS. 1 and 2, this example provides an amino acid teaching aid 100, which presents a molecular structure of an amino acid in which an alpha-carbon atom is connected to an amino group, a carboxyl group, and an R group via chemical bonds by arranging an amino group model, a carboxyl group model and an R group model connected by connectors around an alpha-carbon model. To achieve a detachability on the basis of presenting the structure of amino acid molecules and the positional relationships among various groups as clearly as possible, the teaching aid 100 includes a first part model 1, a second part model 2, and a third part model 3, any two of which are connected at an angle to each other, and optionally, the three models are detachably connected to each other. Here, the first part model 1 includes a first connector 11, a carboxyl group model 12 arranged at one end of the first connector 11 and an implicit alpha-carbon model 13 arranged at the other end of the first connector 11, the second part model 2 includes an amino group model 21, and the third part model 3 includes an R group model 31.

Here, the connecting relationships among various models are as follows: the amino group model 21 is rotatably connected to the alpha-carbon model 13; the R group model 31 is rotatably connected to the alpha-carbon model 13 too, and the carboxyl group model 12 is detachably connected to the amino group model 21 of another adjacent amino acid teaching aid to form a non-rotatable peptide bond.

To realize the above connecting relationships, in this example, the second part model 2 further includes a second connector 22 and a third connector 23 connected at an angle to each other, and the amino group model 21 is arranged at a joint between the second connector 22 and the third connector 23. By convention, the amino group model 21 is a colored in blue.

Here, the third connector 23 includes a flat blade structure arranged at a the amino group end. The carboxyl group model 12 includes a narrow slot 14 for mating with the third connector 23 of an adjacent amino group model 21. The slot is arranged on the departing side of the first connector 11. Thus the amino acid model 100 can symbolically represent a peptide bond structure and simulate its rigid non-rotatable property thanks to the plug-in structures between the flat-blade 23 and the matching slot 14 located on two adjacent amino acids. Moreover, since the carboxyl group contains oxygen atoms, so by convention the carboxyl group model 12 is represented in a red cubic structure to distinguish it from the blue-colored and round amino group. It should be noted that, to simplify the structure in this example, the third connector 23 is shown in a flat-blade structure as a whole. In fact, this technical scheme only restricts the free end of the third connector 23 to a flat-blade structure, but does not limit its main structure. The cross-section thereof can be any one of a circular, elliptical or polygonal shape, all of which fall within the scope of protection of this technical scheme, and will not be described in further detail.

In the first part model 1, the first connector 11 is integrated with or detachably connected to the carboxyl group model 12. When a detachable connection is adopted, the carboxyl group model 12 is connected in a plug-in mode to the end of the first connector 11. To simplify the structure, the first connector 11 is integrated with the carboxyl group model 12 as a single piece in this example.

The first part model 1 further includes a fourth connector 15 and a fifth connector 16, both of which are connected to the alpha-carbon model 13, while any two of the first connector 11, the fourth connector 15 and the fifth connector 16 are arranged at an angle to each other. To truthfully present the corresponding angles of chemical bonds in the amino acid molecules, the first connector 11, the fourth connector 15 and the fifth connector 16 are located in the same plane, and any two of them are at an angle of 120°. In this example, to simplify the structure, the amino group model 21 is shown only by the joint points/intersection points of the first connector 11, the fourth connector 15 and the fifth connector 16.

It is well known that there are 20 different kinds of amino acids that make up proteins. Each amino acid includes a different R group attached to the alpha carbon atom. Inside an amino acid, the R group(s) can rotate around a peptide bond to obtain a spatial configuration with the lowest energy. To show the C—C bond between the alpha-carbon model 13 and the carboxyl group model 12, and to realize the turning of the R-base model 31 around the peptide bond, the second connector 22 is arranged to be plugged into the fifth connector 16 while maintain the rotating freedom, to form a C—C bond by which an angle between groups can be adjusted. Moreover, optionally, the second connector 22 has an annular slot structure, and the fifth connector 16 has a ring-shaped plug-in structure for mating with the annular slot. It should be noted that, to simplify the structure in this example, the second connector 22 is shown in an annular slot structure as a whole, and the fifth connector 16 is shown in a ring plug-in structure as a whole. In fact, this technical scheme only restricts the free end of the second connector 22 as an annular slot structure and the free end of the fifth connector 16 as a ring-shaped plug structure, but does not restrict the main structures thereof. Any shape that can maintain the property of rotatable connection falls within the protection scope of this technical scheme, and is not reiterated in detail.

At the same time, since the R group has a relatively large structure and may interfere with other groups to some extent, it can also rotate based on the C—C bond to adjust the direction of the group to seek for the most stable structure. Therefore, in this example, the R group model 31 is arranged to be rotatably connected to the alpha-carbon model 13. In the specific structure, the third part model 3 further includes a sixth connector 32 arranged at one end of the R group model 31, and the rotation of the R group model 31 is realized through the movable plug-in relationship between the fourth connector 15 and the sixth connector 32. Optionally, the sixth connector 32 has a ring-shaped plug-in structure, and the fourth connector 15 has an annular slot structure for mating with the sixth connector 32. It should also be noted that, to simplify the structure in this example, the sixth connector 32 is shown in a ring-shaped plug-in structure as a whole, and the fourth connector 15 is shown in an annular slot structure as a whole. In fact, this technical scheme only restricts the free end of the sixth connector 32 as a ring-shaped plug-in structure and the free end of the fourth connector 15 as an annular slot structure, but does not restrict the main structures thereof. Any shape that can maintain the property of rotatable connection falls within the protection scope of this technical scheme and is not reiterated in detail.

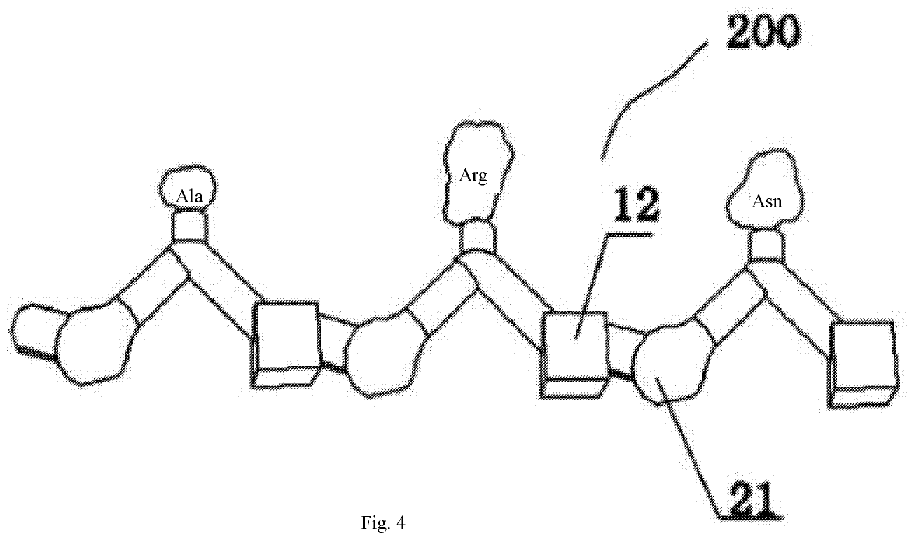

Likewise, to symbolically represent the electron cloud distribution and the electrical properties of the R group, the models 31 exit in different shapes and with colors shades, in which a red part indicates positive electricity and a blue part indicates negative electricity by convention, while the R group models 31 include the 20 models as shown in FIG. 3, and the structure of each R group model 31 is similar to the overall molecular structure of a corresponding R group.

The amino acid teaching aid in this example includes a first part model, a second part model, and a third part model, any two of which are detachably connected at an angle to each other, wherein the first part model includes a first connector, a carboxyl group arranged at one end of the first connector and an alpha-carbon model arranged at the other end of the first connector, the second part model includes an amino group model rotatably connected to the alpha-carbon model, and third part model includes an R group model rotatably connected to the alpha-carbon model. The amino acid teaching aid presents the structures of various parts of an amino acid via the three detachable part models. Moreover, the amino group model and the alpha-carbon model, as well as the R group model and the carboxy model are arranged to be rotatably connected, respectively, and the carboxy group at the alpha-carbon model is arranged to be rigidly connected to the amino group model of an neighboring amino acid. These rotatable connections enable the demonstration of the property that the R group can turn around a peptide bond to obtain the most stable structure.

The amino acid teaching aid of this example includes an amino group model detachably connected to a carboxyl group model of a neighboring amino acid teaching aid to form a non-rotatable peptide bond, demonstrating the rigid and non-rotatable characteristics of the peptide bond.

### Example 2

Referring to FIG. 4, this example provides a peptide chain teaching aid 200 composed of a plurality of amino acid teaching aids 100 of Example 1 connected head to tail.

Protein folding is a process by which a protein obtains its functional structure and conformation. Through this physical process, a protein is folded from an linear amino acid sequence into a specific functional three-dimensional structure. When an mRNA sequence is translated into a linear peptide chain, the final protein always exists in a form of folded polypeptide.

To show this process, in the peptide chain teaching aid of this example, the carboxyl group model 12 of each amino acid is detachably connected to the amino group model 21 of an neighboring unit model, allowing unlimited assembly of strings of amino acids to form a protein. Further, each subunit model of an amino acid can be rotatably connected, respectively, so that in the assembled peptide chain teaching aid 200, the R group model can rotate according to the folded structure of the peptide chain, thereby dynamically representing the three-dimensional structure of the peptide chain or the protein. In addition, the non-rotatable peptide bond connection between the amino group model 21 and the carboxyl group model 12 vividly and faithfully shows the microscopic biological property that the peptide bond is non-rotatable within a protein.

### Example 3

This example provides a protein teaching aid composed of a plurality of amino acid models of Example 1 connected head to tail. It should be noted that the protein teaching aid in this example is structurally similar to the peptide chain of Example 2 except for the difference in the number of the amino acid as included. Likewise, the peptide bond formed by the connection of the amino group model and the carboxyl group model between any two neighboring amino acids can achieve a live presentation where the entire protein model can be produced by the assembly of unlimited number of amino acid units.

It should be noted that the above-description is only a preferred embodiment of the present invention, and is not intended to limit this very invention. Any modification, equivalent replacement, improvement, etc. made within the spirit and principle of the present invention shall fall within the scope of protection of the present invention.

1. An amino acid teaching aid system, comprising: a first part model, a second part model, and a third part model, any two of which are detachably connected at an angle to each other; wherein the first part model comprises a first connector with a carboxyl group model arranged at one end of the first connector and an alpha-carbon model arranged at the other end of the first connector; the second part model comprises an amino group model rotatably connected to the alpha-carbon model; and the third part model comprises an R group model rotatably connected to the alpha-carbon model.

2. The amino acid teaching aid system of claim 1, wherein the amino group model of the teaching aid is detachably connected to a carboxyl group model of an neighboring amino acid model, the connection forming a rigid and non-rotatable peptide bond.

3. The amino acid teaching aid of claim 2, wherein the second part model further comprises a second connector and a third connector which are connected at an angle to each other, and the R group model is arranged at a joint between the first connector and the third connector.

4. The amino acid teaching aid of claim 3, wherein the third connector comprises a flat-blade structure, and the amino group model comprises a narrow slot for mating with the third connector and arranged on a side opposite the first connector.

5. The amino acid teaching aid of claim 1, wherein the first part model further comprises a fourth connector and a fifth connector, both of which are connected to the alpha-carbon model, and any two of the first connector, the fourth connector, and the fifth connector are arranged at an angle to each other.

6. The amino acid teaching aid of claim 2, wherein the first part model further comprises a fourth connector and a fifth connector, both of which are connected to the alpha-carbon model, and any two of the first connector, the fourth connector, and the fifth connector are arranged at an angle to each other.

7. The amino acid teaching aid of claim 3, wherein the first part model further comprises a fourth connector and a fifth connector, both of which are connected to the alpha-carbon model, and any two of the first connector, the fourth connector, and the fifth connector are arranged at an angle to each other.

8. The amino acid teaching aid of claim 4, wherein the first part model further comprises a fourth connector and a fifth connector, both of which are connected to the alpha-carbon model, and any two of the first connector, the fourth connector, and the fifth connector are arranged at an angle to each other.

9. The amino acid teaching aid of claim 5, wherein the third part model further comprises a sixth connector arranged at one end of the R group model, the sixth connector comprising a ring plug-in structure; and the fourth connector comprises an annular slot structure for mating with the sixth connector.

10. The amino acid teaching aid of claim 5, wherein the second connector comprises an annular slot structure, and the fifth connector comprises a ring plug-in structure for mating with the second connector.

11. The amino acid teaching aid of claim 1, wherein the first connector is integrated with the amino group model; or the first connector is detachably connected to the amino group model.

12. The amino acid teaching aid of claim 2, wherein
the first connector is integrated with the amino group model; or
the first connector is detachably connected to the amino group model.

13. The amino acid teaching aid of claim 3, wherein
the first connector is integrated with the amino group model; or
the first connector is detachably connected to the amino group model.

14. The amino acid teaching aid of claim 4, wherein
the first connector is integrated with the amino group model; or
the first connector is detachably connected to the amino group model.

15. The amino acid teaching aid of claim 11, wherein, by convention, the amino group model is colored in blue, indicating the presence of a nitrogen atom, and the carboxyl group model is colored in red, indicating the presence of oxygen atoms.

16. The amino acid teaching aid of claim 1, wherein the R group model comprises 20 different types, and an overall contour or structure of the R group model in each model mimics an actual molecular structure of an R group in a corresponding amino acid.

17. The amino acid teaching aid of claim 2, wherein the R group model comprises 20 different types, and an overall contour or structure of the R group model in each model mimics an actual molecular structure of an R group in a corresponding amino acid.

18. A peptide chain teaching aid, composed of a plurality of the amino acid teaching aids of claim 1 connected head to tail by simulated peptide bonds.

19. The peptide chain teaching aid of claim 18, wherein in the peptide chain, the amino group model of each amino acid model is detachably connected to the carboxyl group model of a neighboring amino acid model.

20. A protein teaching aid, composed of a plurality of the amino acid models according to claim 1 connected head to tail by simulated peptide bonds.
